(19) United States
(12) Patent Application Publication
(10) Pub. No.: US 2007/0271465 A1
(43) Pub. Date: Nov. 22, 2007

(54) Method of Authentication by Challenge-Response and Picturized-Text Recognition

(76) Inventor: James Wu, Taipei (TW)

Correspondence Address: HDSL, 4331 STEVENS BATTLE LANE, FAIRFAX, VA, 22033, US

(21) Appl. No.: 11/383,702

(22) Filed: May 16, 2006

(51) Int. Cl. H04L 9/00

(52) U.S. Cl. 713/183

(57) ABSTRACT

A challenge-response authentication and picturized-text recognition method provides protection from sniffer. When a user ask to login, a server generate a string array and a lookup table corresponding to string array and password character. The lookup table is converted to a graph with noise-adding and distorting treatment. The graph is sent to display of user after decryption. The user can input authentication text according to the shown graph and the password thereof. According to another preferred embodiment of the present invention, the graphic data can also be built-in the memory of the server and a graphic data is randomly selected from the database.

### BACKGROUND OF THE INVENTION

1. Field of the Invention

The present invention relates to an authentication method, especially to authentication method to control the accessing of computer resource.

2. Description of Prior Art

The current authentication method for accessing network such as ATM network generally uses number as password. However, this kind of password is assailable to network hooking program and keyboard recording program. As the applications of network become versatile, it is important issue to protect user account from peep of snooper.

When a user want to request privilege of accessing certain resource such as computer system, database and telecommunication equipment, the user needs to input valid password to prove his authentication. The password is generally composed of English letter and number for facilitating input through terminal or telephone.

In conventional authentication process, the password is input as plain code through keyboard. The input password is exposed to keyboard recording program, packet sniffer or Trojan program. Therefore, data encryption is important to protect user account and password from peeping by packet sniffer or Trojan program.

### SUMMARY OF THE INVENTION

The present invention is intended to provide a picturized text based method for authentication such that sniffer program such as Trojan program or packet sniffer can be prevented.

Accordingly, the present invention provides a challenge-response authentication and text recognition method. When a user ask to login, a server generate a string array and a lookup table corresponding to string array and password character. The lookup table is converted to a graph with noise-adding and distorting treatment to prevent the recognition of Trojan program while the graph can be identify by human eyes. The graph is sent to display of user after decryption.

The user can input authentication text according to the shown graph and the password thereof. According to another preferred embodiment of the present invention, the graphic data can also be built-in the memory of the server and a graphic data is randomly selected from the database.

If the Trojan program has recording function, the sniffer can only get the authentication text, which is corresponding to the random string of the string array and is not the actual password. Moreover, the ordinary Trojan program cannot hacker graphic data. Therefore, the challenge-response authentication and text recognition method according to the present invention can effectively prevent user information from stealing.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of the present invention.

FIG. 2 shows a flowchart of the character-reorganization based method according to the present invention.

FIG. 3 is the schematic diagram of the string identification/processing system.

FIG. 4 is the flowchart of password conversion.

FIG. 5 is the flowchart of password conversion according to another preferred embodiment of the present invention,

FIG. 6 shows a preferred embodiment of the present invention.

FIG. 7 shows another preferred embodiment of the present invention.

FIG. 8 shows an impalement of FIG. 5.

FIG. 9 shows another impalement of FIG. 5.

### DETAILED DESCRIPTION OF THE INVENTION

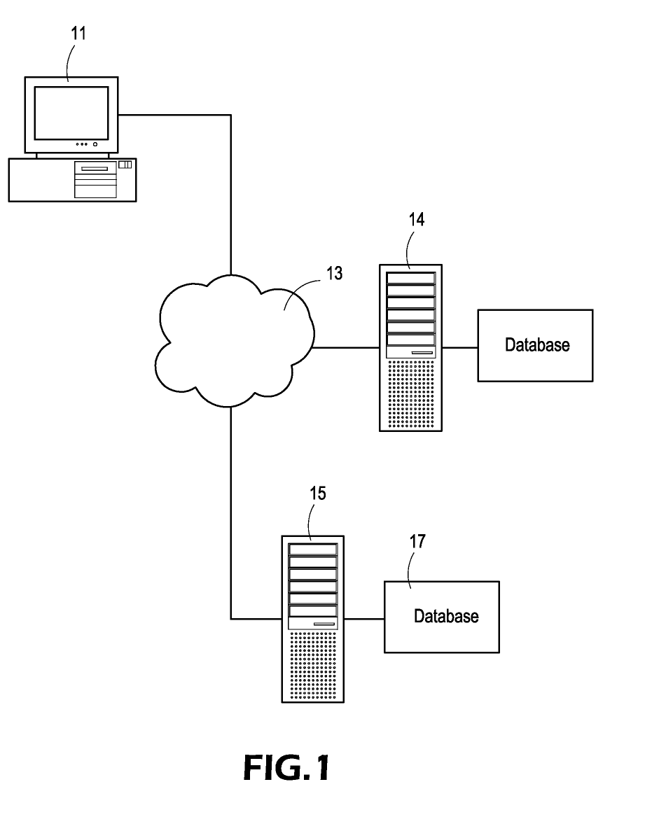

FIG. 1 shows a schematic diagram of the present invention. A user uses a personal computer (PC) 11 to access a remote network server 14 through a communication network 13 such as Internet. The PC 11 generally comprises an input unit such as keyboard. The network server 14 will response to browser program in the in the PC 11 and display login screen for inputting user account and password on display of the PC 11. The user can activate an authentication program after he input his user account and password. The authentication program will verify the input user account and password.

The network server 14 will send the authentication request and information of user to an authentication server 15. The authentication server 15 will open a session for the user and then sends a graphic lookup table to the PC 11 through Internet. The graphic lookup table will be displayed on display of the PC 11. Then the user input his user account and password corresponding to the graphic lookup table for sending this information to the authentication server 15. The authentication server 15 will compare the authentication information with a conversion database 17. The user can be validated when the authentication information is matched with record in the conversion database 17. In this situation the use is allowed to access resource in the network server 14.

The personal information of user will stolen if his user account and password are hackered. A challenge-response authentication can be used to block packer sniffer or keyboard recording program. However, the information input in plain code is still exposed to sniffer program such as Trojan program. Therefore, the present invention provides a character-reorganization based method for authorization, which can protect attack from Trojan program.

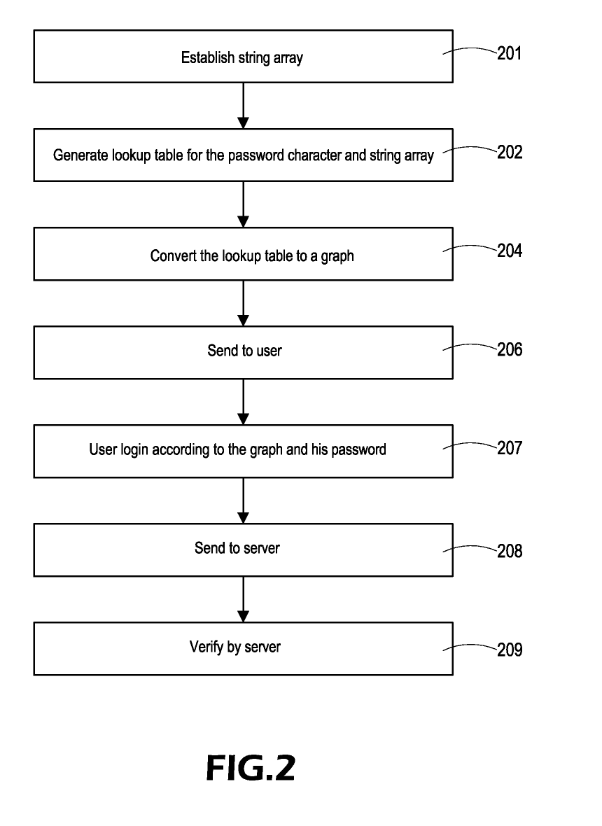

FIG. 2 shows a flowchart of the character-reorganization based method according to the present invention. The authentication server 15 establishes a random string array 16A corresponding to a password character 16B (steps 21 and 22), where each character in the password character is corresponding to each string of the string array 16A. In step 24, a lookup table 16 for the random string array 16A and the password character 16B is converted to a graphic data 18. In step 206, the graphic data 18 is sent to user. The user determines an authorization string based on the password thereof, the graphic data 18 on his display and the lookup table 16 in step 207, and then sends the authorization string to the authentication server 15 in step 208. The authentication server 15 validates the string in step 209. The authorization string is randomly selected from the random string array 16A and is referred to the graphic data 18. Therefore, the authorization string is hard to hacker by Trojan program because the Trojan program cannot identity complicated graphic information.

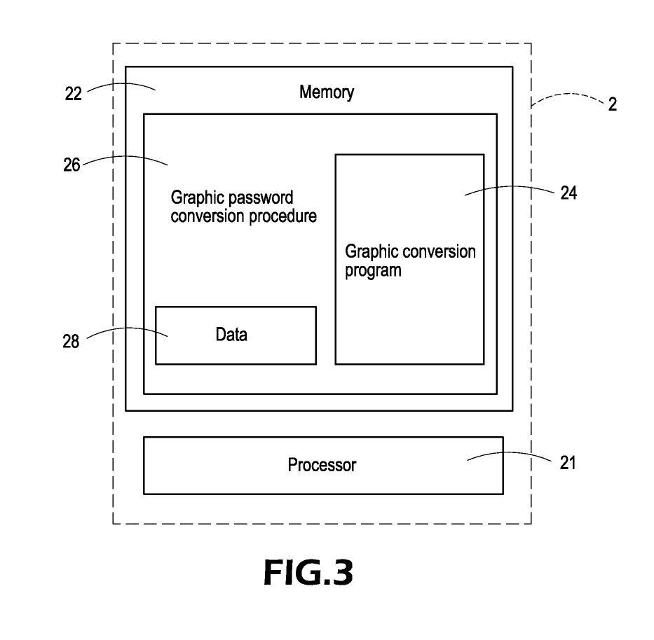

FIG. 3 is the schematic diagram of the string identification/processing system 2, which can be implemented on telephone, telecommunication terminal, PDA or safety register system. For large server, the identification/processing system 2 can be controlled by the authentication server 15. The identification/processing system 2 is controlled by program and includes a memory 22 and a processor 21. The memory 22 stores control program and related data and the processor 21 performs the control program, which are known to those skilled in this art.

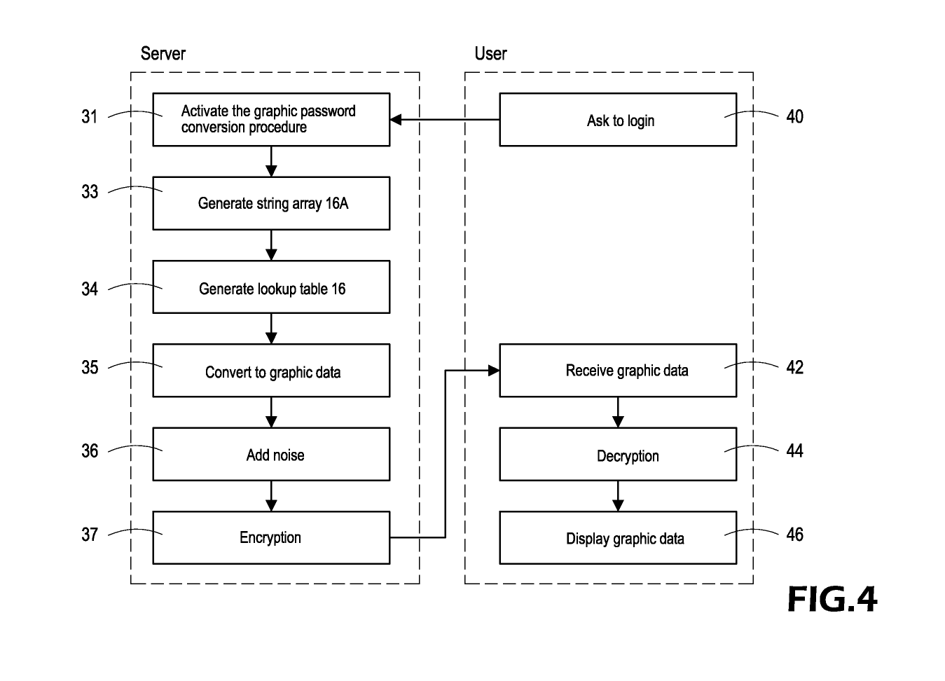

The identification/processing system 2 further includes a graphic password conversion procedure 26. According to a preferred embodiment of the present invention, the graphic password conversion procedure 26 is performed by a graphic conversion program 24 in the memory 22 and a data 28 and the flowchart thereof is shown in FIG. 4.

In step 40, the user asks to login the computer system. In step 31, the graphic password conversion procedure 26 is activated and the string array 16A is generated in step 33, where the string array 16A preferably contains square characters like Chinese characters. The lookup table 16 for the random string array 16A and the password character 16B is generated in step 34, where the password character 16B is preferably generated randomly. For example, when the character in password is number, the password character 16B can be random number like “6152907468” instead of ordered number “0123456789”.

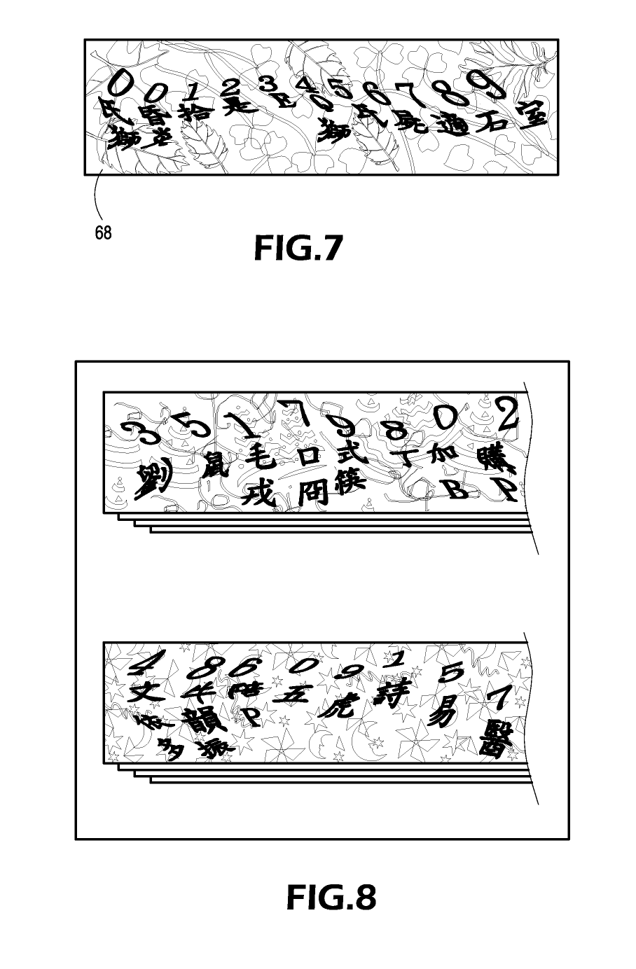

Moreover, the string array 16A comprises at least one string and the string length can be one or more than one. The string can be repeated or non-repeated. The string array is expressed as [string1, string2, string3 . . . ]. When one strings is corresponding to one unique character in the password, the password character and string have one to one mapping. When one string is corresponding to more than one characters, the password character and string have many to one mapping. When more than one strings are corresponding to one character, the password character and string have one to many mapping. When more than one stings are corresponding to more than one characters, the password character and string have many to many mapping. The present invention can be implemented by a mixture of one to one, one to many and many to one mapping, as shown in FIG. 7.

In step 35, the graphic conversion program 24 converts the lookup table 16 into the graphic data 18. To add difficulty in identify the graphic data 18, noise can be added into the graphic data 18 in step 36. In step 37, the graphic data 18 is encrypted to prevent man in the middle attack.

The PC 11 of user receives the graphic data 18 in step 42 and then the graphic data 18 is decrypted in step 44. In step 46, the decrypted graphic data 18 is displayed on the display of the PC 11. Therefore, user can input a text based on the decrypted graphic data on the display of the PC 11. The text is sent back to the string identification/processing system 2. The text is compared with record in the conversion database 17 to identify the user.

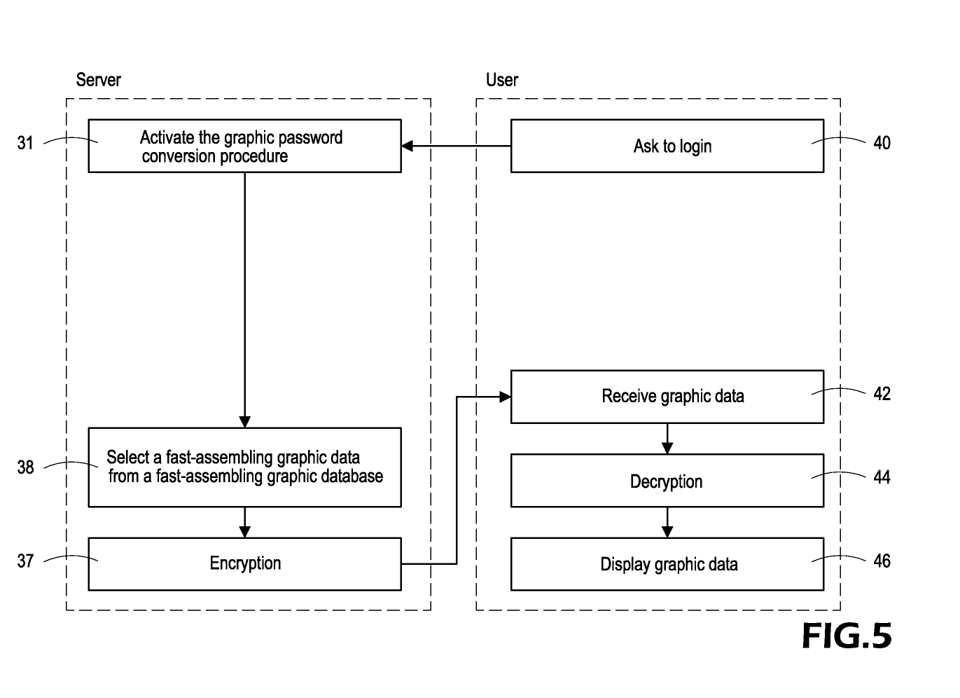

Moreover the graphic data 18 can also be a predefined fast-assembling graphic database 18A. When the graphic password conversion procedure 26 is activated, at least one fast-assembling graphic data 18B is selected from the fast-assembling graphic database 18A. The fast-assembling graphic data 18B is sent to the PC 11 after encryption. The steps shown in FIG. 5 are similar to those shown in FIG. 4 except the steps 33-36 of FIG. 4 are replaced by step 38 in FIG. 5.

The fast-assembling graphic database 18A be can generated by following two ways. The memory 22 is built in with a graphic database. When user asks login, the string identification/processing system 2 will randomly select one fast-assembling graphic data 18B for sending to user. Alternatively, the memory 22 is built in with a plurality of graphic data, where each graphic data is corresponding to each character and string. The combination of the plurality of graphic data is then sent to user by string identification/processing system 2.

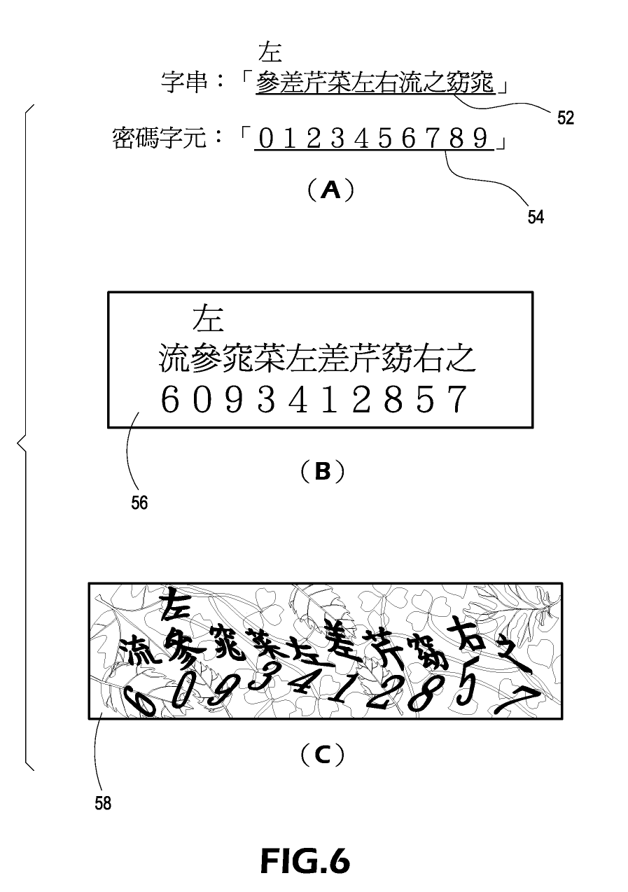

FIG. 6 shows a preferred embodiment of the present invention. As shown in FIG. 6A, when the string identification/processing system 2 receives a login request from user, the string identification/processing system 2 uses the graphic password conversion procedure 26 to generate a lookup table for the string array 52 and password character 54. The string array 52 is preferably composed of square characters such as Chinese character because the square character has difficulty in identification. However, the string array 52 can also be composed of other character or the combination thereof. For example, the random string array 16A can also be Chinese, Japanese character, Korea character n, Thailand character, Arabian character, Sanskrit character, or other Unicode character.

As shown in FIG. 6, the allowable password characters include number 0-9, and the string array 52 generated by the graphic password conversion procedure 26 is [symbol] [symbol] Therefore the lookup table is [symbol] (one to many);

[symbol]

[symbol]

As shown in FIG. 6B, to further protect the password, the order of the string array 52 and password character 54 are changed randomly to form the lookup table 56. Afterward, the graphic conversion program 24 converts the lookup table 56 to a graph 58 as shown in FIG. 6C. The graph is sent to user and shown on computer display.

To protect the graph from hacker, noise can be added into the graph and the original character are distorted. Therefore, the user can input his password based on the lookup table 56. As shown in the embodiment in FIG. 6, the user needs to input [symbol] if his password is “0325.”

Every time when the user asks login, the graphic password conversion procedure 26 will generate different lookup table 16, or send any one of the fast-assembling graphic data 18B. For example, as shown in FIG. 7, when the same user asks to login the same server, the password is still “0325” The random string array 62 generated by the graphic password conversion procedure 26 is [symbol] [symbol] and the password character is “0-0-1-2-3-4-5-6-7-8-9”. Therefore, the password can be either [symbol] or [symbol] .

In the preferred embodiment shown in FIG. 7, there are two strings corresponding to “0” in the password character 64, which is a one to many case; the string [symbol] is corresponding to “0” and “5”, which is a many to one case; the numbers other than “0” and “5” are corresponding to different character. Therefore, FIG. 7 shows a mixed lookup table.

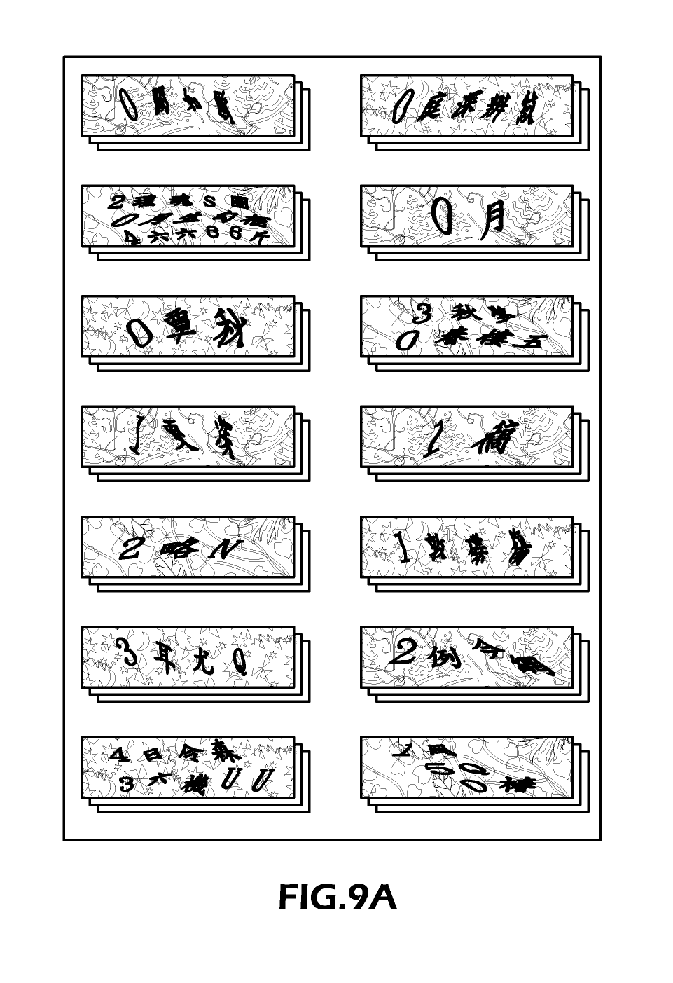

FIG. 8 shows an impalement of FIG. 5. There are a plurality of graphic data in the data 28 of memory and each data contains complete lookup table for password character and string array. As shown in FIG. 8, the graphic conversion program 24 arbitrarily takes a lookup table for sending to the user.

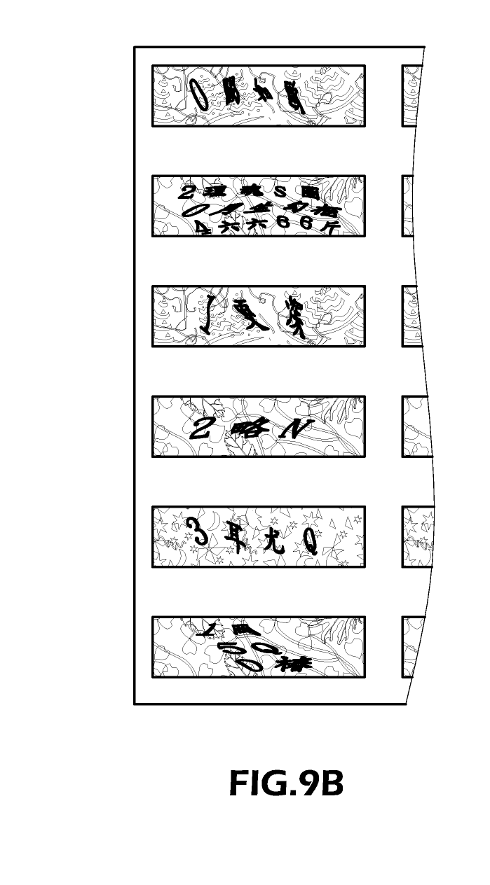

FIG. 9 shows another impalement of FIG. 5. There are a plurality of graphic data in the data 28 of memory and each data contains a partial lookup table for password character and string array. As shown in FIG. 9A, the graphic conversion program 24 arbitrarily takes a plurality of lookup tables and combines the plurality of lookup tables for sending to the user. FIG. 9B shows the combination result. The combination of the plurality of lookup tables contains all password characters.

Even the user does not change password, the input signal to the PC 11 is changed. Therefore, the Trojan program or other sniffer program cannot get the right password even though they can hook the input signal.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An authorization method by picturized text, comprising
generating a string array randomly;
generating a lookup table for password character and the string array;
conversing the lookup table into a graph;
displaying the graph on a display of a computer of a user;
sending an authentication information based on the lookup table and a password of the user; and
verifying the authentication information.

2. The authorization method as in claim 1, where the relationship between the password character and string array is one to one.

3. The authorization method as in claim 1, where the relationship between the password character and string array is one to many.

4. The authorization method as in claim 1, where the relationship between the password character and string array is many to one.

5. The authorization method as in claim 1, where the relationship between the password character and string array is many to many.

6. The authorization method as in claim 1, where the relationship between the password character and string array is a combination of one to one, one to many, many to one and many to many.

7. The authorization method as in claim 1, where each string in the string array comprises at least one character.

8. The authorization method as in claim 1, where the string array comprises alphanumeric.

9. The authorization method as in claim 1, where the string array comprises symbol.

10. The authorization method as in claim 1, where the string array comprises picturized text.

11. The authorization method as in claim 10, where the picturized text is combination of Unicode text.

12. The authorization method as in claim 1, further comprising adding noise to the graph.

13. The authorization method as in claim 1, further comprising distorting the graph.

14. The authorization method as in claim 1, wherein the password characters are ordered randomly.

15. The authorization method as in claim 1, further comprising sending the graph to user computer through Internet.

16. The authorization method as in claim 1, further comprising receiving a signal from input unit of user.

17. The authorization method as in claim 1, wherein the graph is encrypted before sending.

18. An authorization method by picturized text, comprising:
preparing a graphic database containing a plurality of fast-assembling graphic data, each of the fast-assembling graphic data being a picturized lookup table for password character and the string array;
selecting more than one fast-assembling graphic data from the graphic database;
displaying the selected fast-assembling graphic data on a display of a computer of a user;
sending an authentication information based on the lookup table and a password of the user; and
verifying the authentication information.

19. The authorization method as in claim 18, where each of the fast-assembling graphic data is a picturized lookup table for part of the password character and the string array.

20. The authorization method as in claim 19, further comprising selecting a plurality of fast-assembling graphic data to form a complete fast-assembling graphic data containing all password characters.

21. The authorization method as in claim 18, where the fast-assembling graphic data is a picturized lookup table for all the password character and the string array.

22. The authorization method as in claim 18, further comprising sending the fast-assembling graphic data to user through Internet.

23. The authorization method as in claim 18, further comprising receiving a signal from input unit of user.

24. The authorization method as in claim 18, where the relationship between the password character and string array is one to one.

25. The authorization method as in claim 18, where the relationship between the password character and string array is one to many.

26. The authorization method as in claim 18, where the relationship between the password character and string array is many to one.

27. The authorization method as in claim 18, where the relationship between the password character and string array is many to many.

28. The authorization method as in claim 18, where the relationship between the password character and string array is a combination of one to one, one to many, many to one and many to many.

29. The authorization method as in claim 18, where each string in the string array comprises at least one character.

30. The authorization method as in claim 18, where the string array comprises alphanumeric.

31. The authorization method as in claim 18, where the string array comprises symbol.

32. The authorization method as in claim 18, where the string array comprises alphanumeric and symbol.

33. The authorization method as in claim 18, where the picturized text is combination of Unicode text.

34. The authorization method as in claim 18, further comprising adding noise to the graph.

35. The authorization method as in claim 18, further comprising distorting the graph.

36. The authorization method as in claim 18, wherein the password characters are ordered randomly.

37. The authorization method as in claim 18, wherein the fast-assembling graphic data is encrypted before sending.
